(19) United States
(12) Patent Application Publication
(10) Pub. No.: US 2024/0250742 A1
(43) Pub. Date: Jul. 25, 2024

(54) EQUIVALENT OFF STATE FOR A RECONFIGURABLE INTELLIGENT SURFACE

(71) Applicant: QUALCOMM Incorporated, San Diego, CA (US)

(72) Inventors: Narayan Prasad, Westfield, NJ (US); Yavuz Yapici, Florham Park, NJ (US); Tao Luo, San Diego, CA (US); Junyi Li, Fairless Hills, PA (US); Peter Gaal, San Diego, CA (US)

(21) Appl. No.: 18/157,774

(22) Filed: Jan. 20, 2023

(51) Int. Cl. H04B 7/145; H04B 7/0426

(52) U.S. Cl. CPC H04B 7/145; H04B 7/043

(57) ABSTRACT

Methods, systems, and devices for wireless communications are described. A controller of a reconfigurable intelligent surface (RIS) may transmit a capability message indicating a capability of one or more configurable elements of the RIS to direct incoming signals in one or more directions for one or more frequency bands. For example, the configurable elements may have an ability to act as transparent to the signal, to direct the signal in an interference safe direction or frequency, and/or to diffuse the signal across multiple directions or frequencies. The controller of the RIS may control the one or more configurable elements in accordance with the capability message and an activity status of the RIS to direct a signal to at least one direction. In some cases, a network entity may transmit an indication of the at least one direction to the RIS controller.

### FIELD OF TECHNOLOGY

The following relates to wireless communications, including equivalent off state for a reconfigurable intelligent surface (RIS).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support equivalent off state for a reconfigurable intelligent surface (RIS). For example, the described techniques provide for a controller of a RIS to report a capability to direct incoming signals in one or more directions (e.g., preconfigured or otherwise defined). In some cases, the RIS may have a capability to act as transparent, a capability to direct a signal in a direction that may not cause interference (e.g., an interference safe direction), and/or a capability to diffuse the signal across multiple directions or frequencies. The RIS controller may control one or more configurable, or reflective, elements of the RIS to direct the signal to at least one direction in accordance with the capability.

A method for wireless communication at a controller of a RIS is described. The method may include transmitting a capability message including a capability of one or more configurable elements of the RIS to direct incoming signals in one or more preconfigured directions for one or more frequency bands and controlling, in accordance with the capability message and an activity status of the RIS, the one or more configurable elements of the RIS to direct a first signal associated with a first frequency band of the one or more frequency bands to a first preconfigured direction of the one or more preconfigured directions.

An apparatus for wireless communication at a controller of a RIS is described. The apparatus may include a processor, memory coupled with the processor, and instructions stored in the memory. The instructions may be executable by the processor to cause the apparatus to transmit a capability message including a capability of one or more configurable elements of the RIS to direct incoming signals in one or more preconfigured directions for one or more frequency bands and control, in accordance with the capability message and an activity status of the RIS, the one or more configurable elements of the RIS to direct a first signal associated with a first frequency band of the one or more frequency bands to a first preconfigured direction of the one or more preconfigured directions.

Another apparatus for wireless communication at a controller of a RIS is described. The apparatus may include means for transmitting a capability message including a capability of one or more configurable elements of the RIS to direct incoming signals in one or more preconfigured directions for one or more frequency bands and means for controlling, in accordance with the capability message and an activity status of the RIS, the one or more configurable elements of the RIS to direct a first signal associated with a first frequency band of the one or more frequency bands to a first preconfigured direction of the one or more preconfigured directions.

A non-transitory computer-readable medium storing code for wireless communication at a controller of a RIS is described. The code may include instructions executable by a processor to transmit a capability message including a capability of one or more configurable elements of the RIS to direct incoming signals in one or more preconfigured directions for one or more frequency bands and control, in accordance with the capability message and an activity status of the RIS, the one or more configurable elements of the RIS to direct a first signal associated with a first frequency band of the one or more frequency bands to a first preconfigured direction of the one or more preconfigured directions.

Some examples of the method, apparatuses, and non-transitory computer-readable medium described herein may further include operations, features, means, or instructions for receiving control signaling indicating the first preconfigured direction, the first frequency band, or both.

In some examples of the method, apparatuses, and non-transitory computer-readable medium described herein, controlling the one or more configurable elements of the RIS may include operations, features, means, or instructions for controlling the one or more configurable elements of the RIS to direct the first signal in a same direction as an incoming direction of the first signal, where the first preconfigured direction may be based on the incoming direction of the first signal.

In some examples of the method, apparatuses, and non-transitory computer-readable medium described herein, controlling the one or more configurable elements of the RIS may include operations, features, means, or instructions for receiving an indication of the first preconfigured direction.

In some examples of the method, apparatuses, and non-transitory computer-readable medium described herein, the first preconfigured direction includes a set of multiple first preconfigured directions based on the capability message indicating a maximum ratio of reflected power and incident power over the set of multiple first preconfigured directions for the first frequency band.

In some examples of the method, apparatuses, and non-transitory computer-readable medium described herein, controlling the one or more configurable elements of the RIS may include operations, features, means, or instructions for receiving an indication of a set of multiple frequencies for the one or more configurable elements of the RIS to shift at least a portion of a signal power associated with the directed first signal and controlling the one or more configurable elements to shift at least the portion of the signal power to at least a subset of the set of multiple frequencies.

Some examples of the method, apparatuses, and non-transitory computer-readable medium described herein may further include operations, features, means, or instructions for receiving control signaling indicating a second preconfigured direction of the one or more preconfigured directions for the one or more configurable elements of the RIS to direct a second signal associated with a second frequency band of the one or more frequency bands.

Some examples of the method, apparatuses, and non-transitory computer-readable medium described herein may further include operations, features, means, or instructions for receiving an indication of a target interference value corresponding to the directed first signal and determining the activity status based on the target interference value and the capability of the one or more configurable elements of the RIS to direct the incoming signals in the one or more preconfigured directions for the one or more frequency bands.

Some examples of the method, apparatuses, and non-transitory computer-readable medium described herein may further include operations, features, means, or instructions for determining the activity status based on whether a signal may be scheduled to be directed by the RIS towards a target wireless device.

A method for wireless communication at a first network entity is described. The method may include receiving a capability message including a capability of one or more configurable elements of a reconfigurable intelligent surface (RIS) to direct incoming signals in one or more preconfigured directions for one or more frequency bands and transmitting, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.

An apparatus for wireless communication at a first network entity is described. The apparatus may include a processor, memory coupled with the processor, and instructions stored in the memory. The instructions may be executable by the processor to cause the apparatus to receive a capability message including a capability of one or more configurable elements of a RIS to direct incoming signals in one or more preconfigured directions for one or more frequency bands and transmit, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.

Another apparatus for wireless communication at a first network entity is described. The apparatus may include means for receiving a capability message including a capability of one or more configurable elements of a RIS to direct incoming signals in one or more preconfigured directions for one or more frequency bands and means for transmitting, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.

A non-transitory computer-readable medium storing code for wireless communication at a first network entity is described. The code may include instructions executable by a processor to receive a capability message including a capability of one or more configurable elements of a RIS to direct incoming signals in one or more preconfigured directions for one or more frequency bands and transmit, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.

In some examples of the method, apparatuses, and non-transitory computer-readable medium described herein, the first control signaling indicates the first frequency band of the one or more frequency bands.

Some examples of the method, apparatuses, and non-transitory computer-readable medium described herein may further include operations, features, means, or instructions for transmitting, to one or more second network entities, a first message requesting an indication of the one or more frequency bands corresponding to frequency bands in use by the one or more second network entities, where the first message includes a location of the RIS and receiving, in response to the first message, at least one second message indicating the first frequency band.

Some examples of the method, apparatuses, and non-transitory computer-readable medium described herein may further include operations, features, means, or instructions for determining the first preconfigured direction may be a same direction as an incoming direction of the first signal, where the capability message indicates an ability of the RIS to direct the first signal in the same direction as the incoming direction of the first signal.

Some examples of the method, apparatuses, and non-transitory computer-readable medium described herein may further include operations, features, means, or instructions for selecting the first preconfigured direction of the one or more preconfigured directions based on the first preconfigured direction having an interference for one or more wireless devices below a threshold.

Some examples of the method, apparatuses, and non-transitory computer-readable medium described herein may further include operations, features, means, or instructions for transmitting a message requesting location information corresponding to the one or more wireless devices and requesting an indication of respective frequency bands in use by the one or more wireless devices and receiving, in response to the message, the location information and the indication of the respective frequency bands, where selecting the first preconfigured direction may be in accordance with the location information and the indication of the respective frequency bands.

Some examples of the method, apparatuses, and non-transitory computer-readable medium described herein may further include operations, features, means, or instructions for transmitting, to one or more second network entities, signaling including the location information, the indication of the respective frequency bands, the first preconfigured direction, or any combination thereof and receiving updated location information based on transmitting the signaling.

In some examples of the method, apparatuses, and non-transitory computer-readable medium described herein, the first preconfigured direction includes a set of multiple preconfigured directions based on the capability message indicating a maximum ratio of reflected power and incident power over the one or more preconfigured directions for the one or more frequency bands.

Some examples of the method, apparatuses, and non-transitory computer-readable medium described herein may further include operations, features, means, or instructions for transmitting an indication of a set of multiple frequencies for the one or more configurable elements of the RIS to shift at least a portion of a signal power associated with the directed first signal.

Some examples of the method, apparatuses, and non-transitory computer-readable medium described herein may further include operations, features, means, or instructions for determining a time period over which the RIS may be to direct the first signal in the first preconfigured direction and transmitting an indication of the time period to one or more second network entities.

Some examples of the method, apparatuses, and non-transitory computer-readable medium described herein may further include operations, features, means, or instructions for determining that a measurement of interference at a user equipment (UE) associated with a second frequency band of the one or more frequency bands satisfies a threshold interference value and transmitting second control signaling indicating a second preconfigured direction of the one or more preconfigured directions for the one or more configurable elements of the RIS to direct a second signal associated with the second frequency band.

Some examples of the method, apparatuses, and non-transitory computer-readable medium described herein may further include operations, features, means, or instructions for transmitting signaling including reference signal resources associated with the second frequency band and a request for the measurement of interference associated with the second frequency band and receiving, in response to the signaling, the measurement of interference, where determining the measurement of interference satisfies the threshold interference value may be based on receiving the measurement of interference.

Some examples of the method, apparatuses, and non-transitory computer-readable medium described herein may further include operations, features, means, or instructions for receiving, from a second network entity, an indication of the second frequency band, where determining the measurement of interference satisfies the threshold interference value may be based on receiving the indication of the second frequency band.

Some examples of the method, apparatuses, and non-transitory computer-readable medium described herein may further include operations, features, means, or instructions for transmitting an indication of a target interference value corresponding to the directed first signal.

Some examples of the method, apparatuses, and non-transitory computer-readable medium described herein may further include operations, features, means, or instructions for determining the activity status based on whether a signal may be scheduled to be directed by the RIS towards a target wireless device.

### BRIEF DESCRIPTION OF THE DRAWINGS

FIGS. 1 and 2 illustrate examples of wireless communications systems that support equivalent off state for a reconfigurable intelligent surface (RIS) in accordance with one or more aspects of the present disclosure.

FIG. 3 illustrates an example of a process flow that supports equivalent off state for a RIS in accordance with one or more aspects of the present disclosure.

FIGS. 4 and 5 illustrate block diagrams of devices that support equivalent off state for a RIS in accordance with one or more aspects of the present disclosure.

FIG. 6 illustrates a block diagram of a communications manager that supports equivalent off state for a RIS in accordance with one or more aspects of the present disclosure.

FIG. 7 illustrates a diagram of a system including a device that supports equivalent off state for a RIS in accordance with one or more aspects of the present disclosure.

FIGS. 8 and 9 illustrate block diagrams of devices that support equivalent off state for a RIS in accordance with one or more aspects of the present disclosure.

FIG. 10 illustrates a block diagram of a communications manager that supports equivalent off state for a RIS in accordance with one or more aspects of the present disclosure.

FIG. 11 illustrates a diagram of a system including a device that supports equivalent off state for a RIS in accordance with one or more aspects of the present disclosure.

FIGS. 12 through 16 illustrate flowcharts showing methods that support equivalent off state for a RIS in accordance with one or more aspects of the present disclosure.

### DETAILED DESCRIPTION

Some wireless communications systems may implement one or more reconfigurable intelligent surfaces (RISs) to redirect signaling towards a target device (e.g., a user equipment (UE) or a network entity) to extend coverage for wireless communication devices. A RIS may use one or more reflective elements to reflect, or propagate, a wave in a desired direction in a process called RIS reflection beamforming. During RIS reflection beamforming, the RIS may direct a main lobe of a reflection beam toward the target device, and the sidelobes of the beam may point in different directions. Additionally or alternatively, the RIS may include one or more refractive elements. Thus, the RIS may perform reflective beamforming, refractive beamforming, or a combination of the two.

In some cases, other network devices that are communicating near the RIS (e.g., but not using the RIS) may cause interference for the communications to the target device, or other devices within range of the RIS, due to accidental redirection of the communicated signal by the RIS. The interference may impact reception and decoding of the communications between the wireless devices. Thus, the wireless communications system may benefit from powering off the RIS when the RIS is not being used to assist in communications, such as by reducing interference for accidental reflection of nearby communications. However, powering off the RIS may be a power inefficient operation, may cause network delays due to frequent powering off and back on in dynamic environments, or both.

In some examples, a RIS controller may be capable of configuring one or more elements in an equivalent off state. For example, the RIS controller may update one or more parameters of the elements, which may also be referred to as configurable elements, to act as transparent, to direct incoming signals in directions that may cause limited or no interference, or to scatter incoming signals to diffuse the signal power by spreading the power in many directions. The RIS controller may report a capability of the RIS to redirect incoming signals for one or more frequency bands to a network entity. The network entity may exchange communications with neighboring network entities to determine one or more frequencies and location information being used for communications with wireless devices in the proximity and may select one or more directions for a frequency band to which the RIS may direct signals without causing interference for the communications with the wireless devices. The network entity may signal the selected directions, the frequency band, or both to the RIS controller. Additionally, or alternatively, the RIS controller may determine the one or more directions, the frequency band, or both independent of the network entity. In some cases, the RIS controller may control the elements to direct one or more signals for the frequency band in the directions.

Aspects of the disclosure are initially described in the context of wireless communications systems. Aspects of the disclosure are additionally described in the context of process flows. Aspects of the disclosure are further illustrated by and described with reference to apparatus diagrams, system diagrams, and flowcharts that relate to equivalent off state for a RIS.

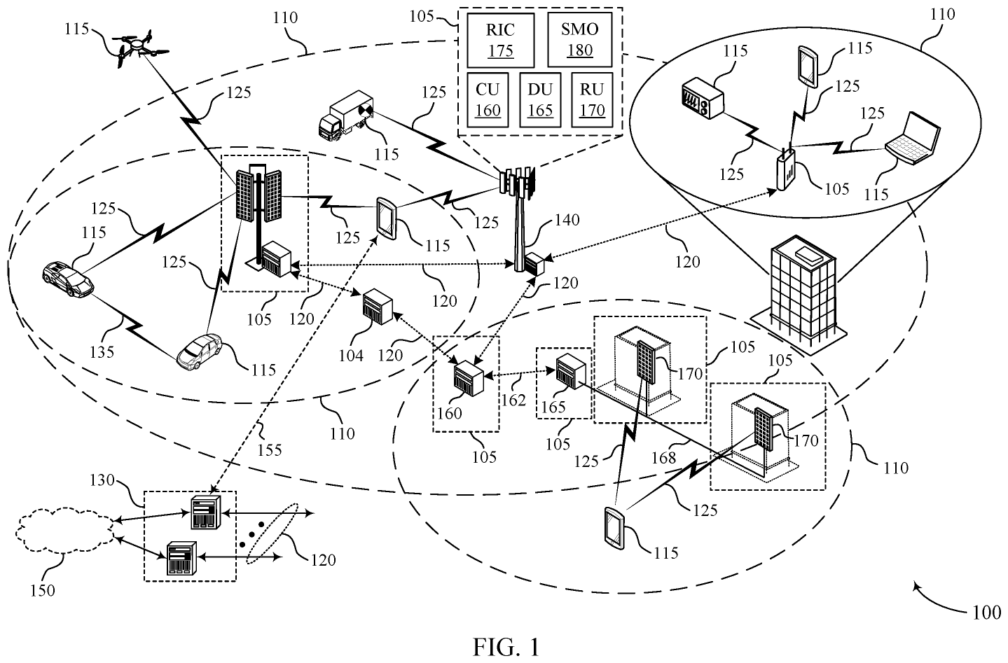

FIG. 1 illustrates an example of a wireless communications system 100 that supports equivalent off state for a RIS in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (MC) 175 (e.g., a Near-Real Time MC (Near-RT RIC), a Non-Real Time MC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support equivalent off state for a RIS as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may implement one or more RISs and RIS controllers to extend coverage and improve spectral efficiency (e.g., by circumventing blockages via new multipaths) with negligible increase to power consumption. In some cases, a RIS controller (e.g., a RIS CU) may configure a characteristic of configurable elements (e.g., reflective or refractive elements) of a RIS to control the redirection characteristic from the RIS. For example, when the RIS is in an active state, or ON state, the RIS controller may control one or more configurable elements of the RIS to direct one or more incoming signals to target wireless devices. In some cases, the RIS may unintentionally reflect signaling not intended for redirection (e.g., a sidelobe of direct signaling between wireless devices) towards another wireless device, which may cause interference for communications at the other wireless device. Thus, when not in use, the network entity 105 may indicate for the RIS to switch to an OFF state when not involved in communications. However, the RIS switching from an ON state to an OFF state may degrade energy efficiency for the wireless communications system 100.

Thus, the wireless communications system 100 may implement an equivalent OFF state for the RIS, in which the RIS directs incoming signaling not intended for redirection in one or more directions or frequencies that may not cause interference (e.g., an interference safe direction or frequency), instead of switching the RIS to the OFF state. In some cases, the configurable elements of the RIS may have the capability to act as transparent, such as by directing an incoming signal in a same direction as the incoming signal. In some other cases, the configurable elements of the RIS may have the capability to direct an incoming signal in a direction that the controller of the RIS determines may not cause interference for other wireless devices. Additionally, or alternatively, the configurable elements of the RIS may be capable of scattering an incoming signal in multiple directions or frequencies, which may be referred to as dithering a signal, or dither. The controller of the RIS may send a capability message indicating one or more of the capabilities of the RIS to act as transparent, direct an incoming signal in an interference-safe direction, or dither an incoming signal, such as for a frequency band or frequency range. The controller of the RIS may control the configurable elements of the RIS in accordance with the capability. In some cases, the network entity 105 may indicate a direction or frequency to which the RIS may direct the incoming signal.

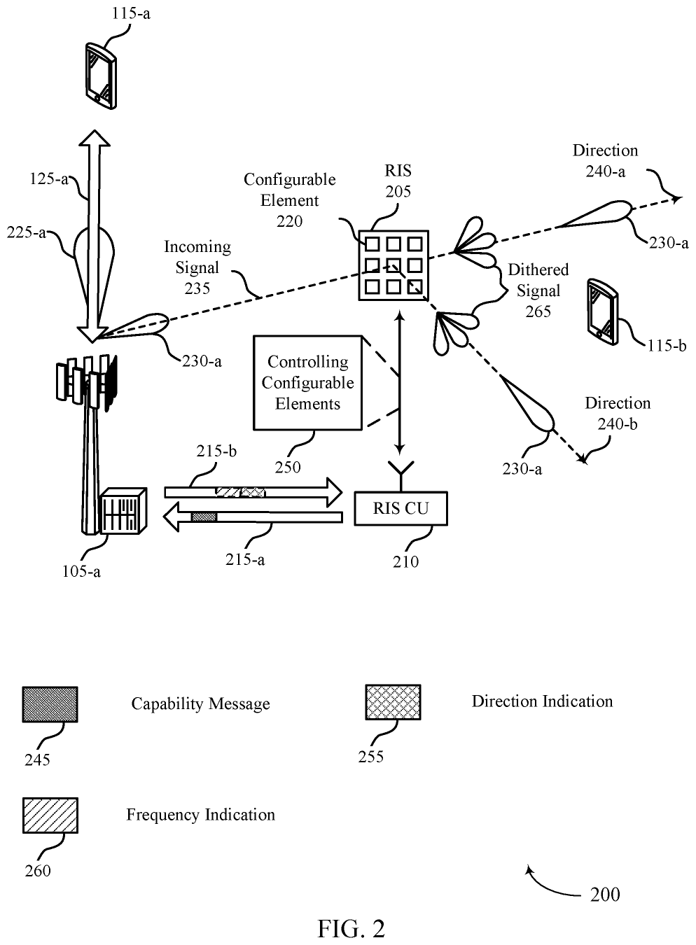

FIG. 2 illustrates an example of a wireless communications system 200 that supports equivalent off state for a RIS in accordance with one or more aspects of the present disclosure. The wireless communications system 200 may implement or be implemented to realize aspects of the wireless communications system 100. For example, the wireless communications system 200 illustrates communication between a UE 115-a, a UE 115-b, and a network entity 105-a, which may be examples of corresponding devices described herein, including with reference to FIG. 1. In some cases, the UE 115-a and the network entity 105-a may communicate via a communication link 125-a, which may be an example of a communication link 125 as described with reference to FIG. 1. A RIS 205 may direct a signal in one or more directions to reduce or prevent interference at the UE 115-b from communications between the network entity 105-a and the UE 115-a.

In some cases, a network entity 105-a may be in communication with one or more other network entities, such as a controller of the RIS 205 (e.g., a RIS CU 210). In some other examples, the network entity 105-a may be the controller of the RIS 205. The RIS CU 210 may be referred to as a network entity, or any other controlling device (e.g., any device capable of wirelessly transmitting or receiving or capable of configuring or otherwise controlling one or more assisting devices), and may transmit signaling to the network entity 105-a via a communication link 215-a, may receive signaling from the network entity 105-a via a communication link 215-b, or both.

In some examples, the wireless communications system 200 may implement one or more RISs 205 to extend coverage and improve spectral efficiency (e.g., by circumventing blockages via new multipaths) with negligible increase to power consumption. A RIS 205 may include an array of passive and reconfigurable elements, which a RIS CU 210 may control. The new multipaths introduced by the RIS 205 may provide for a transmitting device to communicate with a receiving device that may otherwise not be within a communication range, such as due to objects blocking a line-of-sight (LoS) of communication between the transmitting device and the receiving device. Additionally, or alternatively, the RIS 205 may provide for selection of propagation features for communications.

In some cases, a RIS CU 210 may configure a characteristic of the RIS 205 to control the redirection properties of the RIS 205 with respect to one or more signals. For example, when the RIS is in an active state, or ON state, the RIS CU 210 may control one or more configurable elements 220 of the RIS 205 to direct one or more signals for communications using a reflection matrix, or reflection coefficients, for each of the configurable elements 220. That is, the network entity 105-a may transmit or receive control signaling, data, or both to and from a UE via the RIS 205, which may be a near passive device (e.g., may not have power amplifiers) capable of redirecting an impinging or incident wave to a desired location or in a desired direction. The network entity 105-a may transmit messaging to the RIS CU 210 indicating a configuration (e.g., coefficient matrix for the configurable elements 220) of the RIS 205, and the RIS CU 210 may configure the RIS 205 accordingly. For example, the RIS CU 210 may apply each of the coefficients to the configurable elements 220 of the RIS 205.

A RIS 205 may function similarly to a mirror or other reflective surface in its ability to reflect incident beams or waves (such as light waves), but may differ in that a RIS 205 may include one or more components that may control how an incident beam or wave is reflected (such that an angle of incidence can be different than an angle of reflection). Additionally, or alternatively, the RIS 205 may control a shape of a reflected beam or wave, such as via energy focusing or energy nulling via constructive interference or destructive interference, respectively. For example, a RIS 205 may include a quantity of configurable elements 220 that each have a controllable delay, phase, or polarization, or any combination thereof. The RIS CU 210 may configure each of the configurable elements 220 to control how an incident beam or wave may be reflected or to control a shape of a reflected beam or wave. A RIS 205 may be an example of or may otherwise be referred to as a software-controlled metasurface, a configurable reflective surface, a reflective intelligent surface, or a configurable intelligent surface, and may sometimes be a metal surface (e.g., a copper surface) including a quantity of configurable elements 220. In some aspects, a RIS CU 210 may be coupled with a RIS 205 via hardware (such as via a fiber optic cable). In some other aspects, a RIS CU 210 may be non-co-located with a RIS 205 and may configure the RIS 205 via over-the-air signaling. Although generally described herein as a reflective surface, it should be understood that an RIS 205 may alternatively or additionally include refractive elements that may also control an angle of redirection or a shape of a redirected beam or wave.

In some cases, a network entity 105-a and a UE 115-a may establish a communication link 125-a with each other and may communicate using a beamforming technique. For example, the network entity 105-a may transmit signaling via a beam with a main lobe 225-a and a sidelobe 230-a, to a UE 115-a. However, when the network entity 105-a generates the main lobe 225-a of the beam, the network entity 105-a may also generate a sidelobe 230-a in a different direction, such as towards the RIS 205. The RIS 205 may unintentionally reflect the sidelobe 230-a towards another wireless device. For example, the RIS 205 may unintentionally reflect the sidelobe 230-a towards the UE 115-b, which may cause interference for communications at the UE 115-b.

Thus, the network entity 105-a may indicate for the RIS 205 to switch to an OFF state (e.g., via the RIS CU 210) when not involved in communications. For example, when the RIS 205 is not assisting in reflecting signaling between wireless devices, the RIS 205 may switch to an OFF state to avoid causing interference to nearby wireless devices or network nodes. However, switching the RIS 205 from an ON state to an OFF state may increase power consumption at the RIS 205. Further, the frequency to which the RIS 205 switches between the ON and OFF states may increase for dynamic signaling environments, which may further degrade energy efficiency for the wireless communications system 200.

Thus, the wireless communications system 200 may implement an equivalent OFF state for the RIS 205, in which the RIS CU 210 controls the configurable elements 220 to direct the signaling in one or more directions or frequencies that may not cause interference (e.g., an interference safe direction or frequency), instead of switching the RIS to the OFF state. In some cases, the RIS CU 210 may determine the configurable elements 220 of the RIS 205 are capable of directing an incoming signal 235 from the sidelobe 230-a in one or more directions, such as based on design considerations of the configurable elements 220.

In some cases, the configurable elements 220 of the RIS 205 may have the capability to act as transparent, such as by directing an incoming signal 235 in a same direction 240-a as the incoming signal 235. If the configurable elements 220 of the RIS have the capability to act as transparent, the RIS CU 210 may be aware of this capability, and may report the capability to the network entity 105-a in a capability message 245. The capability message 245 may be dedicated to the capability information of the RIS 205, or may be included in other control signaling. In some cases, the RIS CU 210 may transmit the capability message 245 to the network entity 105-a in control signaling and/or based on a request from the network entity 105-a. Then, at 250, the RIS CU may control the configurable elements 220 of the RIS 205, to provide for an incident wave to pass through the RIS in a direction 240-a, which may be a same direction as the incoming signal 235. For example, the configurable elements 220 of the RIS 205 may direct the incoming signal 235 resulting from the sidelobe 230-a towards the direction 240-a, such that the sidelobe 230-a continues on in the direction 240-a.

In some cases, the RIS CU 210 may control the configurable elements 220 of the RIS 205 to act as transparent for one or more frequency ranges, such as to avoid an impedance mismatch between the configurable elements 220 of the RIS 205 and the wave travelling in the direction 240-a. For example, the impedance of the configurable elements 220 of the RIS 205 may depend on a carrier frequency of the incoming signal 235. An impedance mismatch may cause signal reflection back to the source of the signal (e.g., the network entity 105-a for the incoming signal 235). As such, the RIS CU 210 may control the configurable elements 220 of the RIS 205 to act as transparent at a frequency band with no impedance mismatch, but not for a frequency band with impedance mismatch, due to the impedance mismatch causing the RIS 205 to reflect at least some portion of the incident wave back towards the source of the incoming signal 235. The network entity 105-a may determine one or more frequency bands, or frequency ranges, in use by surrounding wireless devices to determine which frequency bands may cause impedance mismatch at the RIS 205.

In some cases, the network entity 105-a may determine one or more frequency bands in use within a geographical location (e.g., nearby area to the network entity 105-a). For example, the network entity 105-a may communicate with other wireless devices in the wireless communications system 200 to obtain an indication of which frequency bands are in use. Additionally, or alternatively, the network entity 105-a may determine a location of the RIS 205 (e.g., from the RIS CU 210, or by other means). The network entity 105-a may use the indication of the frequency bands in use as well as location information of the RIS 205 to determine which services may be impacted by interference originating from the RIS 205 (e.g., from the incoming signal 235). In some cases, the network entity 105-a may send a message to one or more wireless devices (e.g., base stations, UEs, or other network entities) that may be impacted by the interference to request a frequency band usage report. The wireless devices may each report one or more current frequency bands in use to the network or directly to the network entity 105-a.

In some cases, the network entity 105-a may transmit a direction indication 255 to the RIS CU 210, indicating one or more directions for the RIS CU 210 to control the configurable elements 220 to direct the incoming signal 235. The direction indication 240 may include the direction 240-a if there is little or no impedance mismatch for the current frequency bands in use (e.g., if the impedance mismatch satisfies a threshold value). Additionally, or alternatively, the network entity 105-a may transmit a frequency indication 260 to the RIS CU 210 that indicates one or more frequency bands, or frequency ranges, that may cause impedance mismatch at the RIS 205. Thus, the network entity 105-a may reconfigure the RIS 205 via the RIS CU 210 with a transparent configuration if the RIS 205 is not assisting in other communication (e.g., the activity status of the RIS 205 is not active), and if there is minimal impedance mismatch. Additionally, or alternatively, the network entity 105-a may shift, or may indicate for the wireless devices to shift, a carrier frequency of the incoming signal 235 to a frequency band with an impedance mismatch that satisfies a threshold value in the direction 240-a. When the RIS 205 acts as transparent, the RIS 205 may maintain an ON state, while reducing or avoiding RIS-originated interference.

In some examples, the network entity 105-a may determine a time period over which the RIS 205 is to act as transparent in the reported frequency bands, such as based on the location information of the RIS 205, scheduling information for the incoming signal 235, and the frequency bands in use. The network entity 105-a may transmit an indication of the time period to surrounding wireless devices (e.g., other network entities), or to the network. In some cases, if a network entity 105-a starts using another frequency band, the network entity 105-a may configure the UEs served in the new frequency band with CSI-RS resources, and may request interference measurements from the UEs. If the measurement report indicates that the interference exceeds a threshold value, the network entity 105-a may report the new frequency band to the network to report to the RIS CU 210, or directly to the RIS CU 210, to update the directions to which the RIS 205 reflects the incoming signal 235 (e.g., to reduce the interference). For example, the network entity 105-a may determine an incoming signal 235 on a new frequency band exceeds an interference threshold value at a UE 115-b, and may send an updated configuration to the RIS CU 210 (e.g., via the communication link 215-b) for controlling the configurable elements 220 of the RIS 205 to reduce the interference of the incoming signal at the UE 115-b.

In some other examples, the network entity 105-a may configure the RIS CU 210 with an interference-safe configuration if the RIS 205 is not assisting with communications, such that the RIS 205 may steer an incident beam (e.g., the sidelobe 230-a) towards a direction indicated by the network entity 105-a to be safe. The network entity 105-a may determine the interference-safe configuration based on the location of the RIS 205, the location of one or more surrounding wireless devices (e.g., the location of the UE 115-b), scheduled communications for one or more surrounding wireless devices, or any combination thereof. For example, a safe direction may be a direction that minimizes, or otherwise reduces, interference for surrounding wireless devices, such as for the UE 115-b, caused by the RIS 205. The direction 240-b may be an example of a safe direction because if the configurable elements 220 of the RIS 205 direct the incoming signal 235 towards the direction 240-b, the UE 115-b may not experience interference from the incoming signal 235.

In some cases, the network entity 105-a may transmit a message to the network to request location information and frequency band usage for surrounding wireless devices, such as UEs, network entities, other network nodes, and mobile network nodes (e.g., mobile IAB nodes, UEs). The network may send a message to the surrounding network entities, or base stations, to determine whether the surrounding wireless devices are currently receiving service. The surrounding network entities may report the location information and frequency band information for the wireless devices that are receiving service to the network (e.g., to relay to the network entity 105-a) or directly to the network entity 105-a. The network entity 105-a may determine a configuration (e.g., set of parameters for directing signals) for the configurable elements 220, such that a reflection from the RIS 205 within the reported frequency bands is not directed to any surrounding wireless devices. Further, the network entity 105-a may configure the transmission to the UE 115-a, such that the sidelobe 230-a does not point towards the surrounding wireless devices.

In some examples, the network entity 105-a may indicate the configuration for the direction 240-b to the RIS CU 210, such as in the direction indication 255 via the communication link 215-b. The network entity 105-a may transmit the direction indication 255 to the RIS CU 210 in control signaling, such as with other information (e.g., with the frequency indication 260) or in a dedicated message. Thus, the RIS CU 210 may control the configurable elements 220 of the RIS 205 to direct an incoming signal 235 (e.g., from the sidelobe 230-a) to a direction 240-b that the network entity 105-a indicates to be interference-safe. In some examples, the network entity 105-a may determine a time period, or duration, for the chosen configuration (e.g., the configuration for the direction 240-b) to remain in effect, such as based on the reported location information and frequency band information from surrounding wireless devices. The network entity 105-a may transmit an indication of the time period to the RIS CU 210, to the surrounding wireless devices, to the network, or any combination thereof.

Similarly, the network entity 105-a may report the directions of the sidelobe 230-a (e.g., the direction of the incoming signal 235 and/or the direction 240-b), the main lobe 225-a, or both to the RIS CU 210, to the surrounding wireless devices, to the network, or any combination thereof. The network and/or surrounding wireless devices may monitor for any overlap in communication direction with the direction of the main lobe 225-a, the sidelobe 230-a, or both, and may transmit a report indicating the overlap if the overlap occurs.

In some cases, the RIS 205 may be a PIN-diode-based RIS, which may be referred to as a binary RIS. For a binary RIS, each configurable element 220 may be set to one of two states (e.g., ON and OFF). For an ON state, the configurable element 220 may have a forward bias and current flow. For an OFF state, the configurable element 220 may have a reverse bias and no current flow. In some examples, the RIS 205 may operate using a dithered configuration, and may thus be referred to as a dithered binary RIS. For the dithered configuration, when the configurable elements 220 are in an OFF state (e.g., the lowest power state), the RIS 205 may appear as a finely broken mirror, such that an incoming signal 235 is scattered in many incident directions. That is, if the RIS 205 has the capability to operate using a dithered configuration, the RIS 205 may scatter an incoming signal 235 into a dithered signal 265 in multiple directions using the configurable elements 220, rather than along a single direction. Dither capability or inherent dither capability can, for instance, be obtained via pre-set or pre-fabricated phase-offsets realized on the configurable elements 220.

In some examples, the RIS CU 210 may report the capability of the RIS 205 to dither an incoming signal 235 in the capability message 245. For example, the RIS CU 210 may report a capability of the RIS 205 to dither an incoming signal 235 for a given set of incident directions, such as a maximum ratio of reflected power and incident power over multiple reflected directions or over multiple directions deemed safe to introduce interference. Additionally, or alternatively, the RIS CU 210 may report a capability of the RIS 205 to dither an incoming signal 235 per operating frequency or frequency band or per polarization. The network entity 105-a may indicate a reflected signal suppression condition to the RIS CU 210 based on interference at surrounding wireless devices, which may include a set of safe directions in the direction indication 255, a set of safe frequencies in the frequency indication 260, or both. The RIS CU 210 may determine an OFF state configuration for the configurable elements 220 (e.g., how many configurable elements 220 to use to dither the incoming signal 235 and in which directions or frequencies) based on an inherent dither capability of the RIS 205 and the signal suppression condition from the network entity 105-a.

For example, the RIS CU 210 may determine the OFF state configuration for the configurable elements 220 based on a space-frequency dither via a time-varying control of the reflection coefficient of each configurable element 220. In some cases, the RIS CU 210 may generate and select independent and identically distributed binary or quaternary or octonary valued static dither, {Γᵢ}ᵢ₌₁^{N}, for reflection coefficients, where i is a configurable element 220 and Γᵢ is the reflection coefficient for the configurable element 220. The reflection coefficient may be made to be time-varying (e.g., with period Tₒ), such as according to a function of time Γ(t). The RIS CU 210 may use a same multiplicative periodic time-varying control function, Γ(t), for each of the configurable elements 220. Thus, for each configurable element, the reflection coefficient may be ΓᵢΓ(t).

In some other cases, the RIS CU 210 may RIS CU 210 may select an independent and identically distributed delay offset, {tₒⁱ}ᵢ₌₁^{N}, where i is a configurable element 220 and tₒⁱ is the delay offset for the configurable element 220 that is uniformly drawn from {0, Tₒ/4, T₀/2, 3Tₒ/4}. The RIS CU 210 may configure the RIS 205 to apply a delayed multiplicative time-varying control of Γ(t−tₒⁱ) to each configurable element 220, such that a reflection coefficient of the i^{th} configurable element 220 is Γ(t−tₒⁱ).

In some examples, the RIS CU 210 may configure the RIS 205 such that at the 0^{th} harmonic and at any other even harmonic (e.g., frequency k/Tₒ: k even), the RIS 205 may not reflect a signal. At a k^{th} odd harmonic (e.g., frequency k/Tₒ: k odd), the RIS CU 210 may configure a soft-off isolation of approximately X decibels (dB)+4 dB+20 log₁₀(k), where k=1,3,5, . . . and XdB is the soft-off isolation provided by using static binary dither {Γᵢ}ᵢ₌₁^{N} without time-varying control, to provide for a relatively low reflected signal power when compared with an incident signal power. For example, X may have a value of −13 for a 12 configurable element by 12 configurable element uniform planar array (UPA) RIS with 0.4λ inter-element spacing with binary valued static dither and −14.7 with quaternary valued static dither, where λ is wavelength.

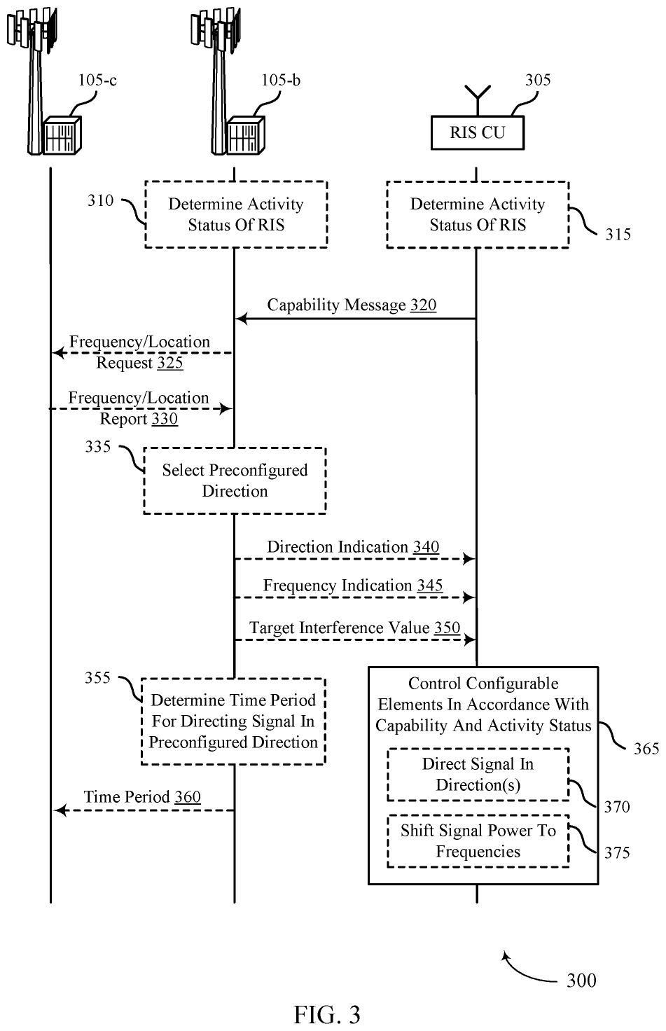

FIG. 3 illustrates an example of a process flow 300 that supports equivalent off state for a RIS in accordance with one or more aspects of the present disclosure. In some examples, the process flow 300 may implement aspects of the wireless communications system 100 and the wireless communications system 200. The process flow 300 may illustrate an example of a RIS controller, such as a RIS CU 305, transmitting a capability message to a network entity 105-b indicating a capability of the RIS CU 305 to direct signals in one or more directions for one or more frequency bands, where the RIS CU 305 controls configurable elements of a RIS based on the capability message. The network entity 105-b, the network entity 105-c, and RIS CU 305 may be examples of network entities 105 and a RIS CU 210 as described with reference to FIGS. 1 and 2. Alternative examples of the following may be implemented, where some processes are performed in a different order than described or are not performed. In some cases, processes may include additional features not mentioned below, or further processes may be added.

In some examples, the RIS CU 305 may be referred to as a network entity. In some other examples, the network entity 105-b may perform the actions of the RIS CU 305. The actions performed by the network entity 105-b may additionally, or alternatively, be performed by a controlling UE for sidelink communications.

At 310 and 315, a network entity 105-b and a controller of a RIS, such as the RIS CU 305, respectively, may determine an activity status of the RIS. The activity status of the RIS may depend on whether the RIS is scheduled to assist in any communications. If the RIS is not scheduled to assist in any communications, the RIS CU 305 may configure the equivalent OFF state of the RIS, while if the RIS is scheduled to assist in any communications, the RIS CU 305 may maintain an active state, or ON state, of the RIS until the communications terminate.

At 320, the RIS CU 305 may transmit a capability message to the network entity 105-b indicating a capability of one or more configurable elements (e.g., reflective elements, refractive elements) of the RIS to redirect incoming signals in one or more preconfigured directions for one or more frequency bands. The preconfigured directions may be determined by the RIS CU 305, may be indicated by the network entity 105-b, may depend on a functionality (e.g., design factor) of the configurable elements of the RIS, or any combination thereof.

At 325, the network entity 105-b may transmit a message to one or more other network entities or surrounding wireless devices (e.g., the network entity 105-c) requesting an indication of one or more frequency bands in use by the other network entities or surrounding wireless devices and location information of the network entities and/or wireless devices served by the network entities. The message may include location information of the RIS.

At 330, the network entity 105-c may respond with a message indicating a frequency band of a signal that is an incoming signal to the RIS. Additionally, or alternatively, the network entity 105-c may respond with a message indicating a set of frequency bands in use at the network entity 105-c and location information for one or more wireless devices served by the network entity 105-c (e.g., including mobile wireless devices). In some examples, the network entity 105-b may report the frequency and location information from each surrounding wireless device to the network entity 105c, and the network entity 105-c may update the location information accordingly (e.g., if any frequency band or location information has changed).

At 335, the network entity 105-b may select a preconfigured direction for the RIS to direct the incoming signal to, such as based on the preconfigured direction having an interference value at surrounding wireless devices that satisfies a threshold interference value (e.g., below the threshold interference value). The network entity 105-b may select the preconfigured direction based on the location information and frequency bands in use at the network entity 105-c.

In some examples, at 340, the network entity 105-b may transmit the selected preconfigured direction to which the RIS CU 305 should direct an incoming signal based on the capability message and an activity status of the RIS (e.g., whether or not the RIS is actively assisting in communications). In some examples, the network entity 105-b may send control signaling indicating different preconfigured directions for signals on different frequency bands. For example, the network entity 105-b may instruct the RIS CU 305 to control the configurable elements of the RIS to direct a first signal on a first frequency band to a first direction and a second signal on a second frequency band to a second direction.

Additionally, or alternatively, at 345, the network entity 105-b may determine and transmit a frequency band, or frequency range, over which the RIS CU 305 should direct an incoming signal based on the capability message and the activity status of the RIS. In some cases, the network entity 105-b may transmit an indication of multiple frequencies to which the one or more configurable elements of the RIS should shift at least a portion of a signal power of an incoming signal.

At 350, the RIS CU 305 may receive an indication of a target interference value for a directed signal at the RIS. For example, the target interference value may be a maximum threshold tolerance at for one or more surrounding wireless devices. The RIS CU 305 may determine one or more parameters (e.g., reflective coefficients) of an OFF state for the RIS based on the target interference value and the capability of the one or more configurable elements of the RIS to direct the incoming signals in the one or more preconfigured directions for the one or more frequency bands. That is, the RIS CU 305 may determine on a per configurable element basis whether to configure the configurable element to direct the incoming signal, or whether a current reflection coefficient of the configurable element satisfies the target interference value.

At 355, the network entity 105-b may determine a time period, or duration, over which the RIS is to direct the first signal in the first preconfigured direction.

At 360, the network entity 105-b may transmit an indication of the time period to one or more other network entities or surrounding wireless devices, such as the network entity 105-c. The network entity 105-c may update the network entity 105-b if any location information or frequency band usage information changes during the time period, which may update the preconfigured direction.

At 365, the RIS CU 305 may control the one or more configurable elements of the RIS to direct a signal sent using a frequency band to a preconfigured direction (e.g., the preconfigured direction indicated by the network entity 105-b). The RIS CU 305 may control the configurable elements in accordance with the capability message and the activity status of the RIS.

For example, at 370, if the RIS is capable of acting as transparent for the frequency band of the incoming signal, the RIS CU 305 may control the one or more configurable elements of the RIS to direct the signal in a same direction as an incoming direction of the signal. In some other examples, the RIS CU 305 may control the one or more configurable elements of the RIS to direct the signal in a direction that is interference-safe, such that a threshold interference value is satisfied for the directed signal. Additionally, or alternatively, the RIS may be capable of dithering an incoming signal, such that the RIS CU 305 may control the one or more configurable elements to direct the signal in multiple preconfigured directions in accordance with a maximum ratio of reflected power and incident power over the multiple preconfigured directions. The capability message may include an indication of the maximum ratio of reflected power and incident power over the multiple directions.

In some cases, at 375, the RIS may be capable of shifting the signal power from an incoming signal to one or more frequency bands. For example, the RIS CU 305 may control the configurable elements of the RIS to shift at least a portion of incoming signal power to at least a subset of the frequencies indicated at 345.

In some examples, the network entity 105-b may determine that a measure of interference at a UE satisfies (e.g., exceeds) a threshold interference value for a frequency band, and may transmit control signaling to the RIS CU 305 indicating an updated direction for the one or more configurable elements of the RIS to direct signals sent using the frequency band. The network entity 105-b may send reference signal resources (e.g., CSI-RS resources) for the frequency band and a request for the measurement of interference to the UE. Additionally, or alternatively, a network entity serving the UE may indicate the frequency band and an indication that the interference at the UE satisfies the threshold interference value for the frequency band.

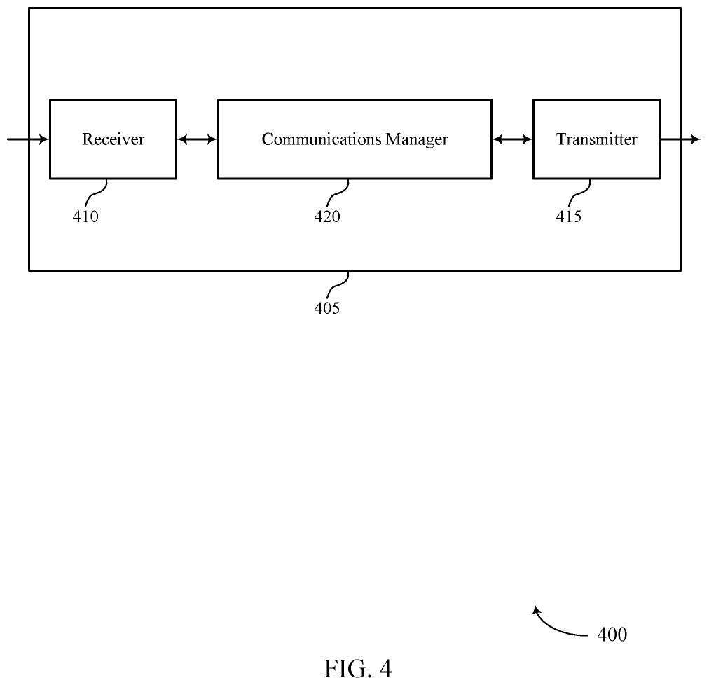

FIG. 4 illustrates a block diagram 400 of a device 405 that supports equivalent off state for a RIS in accordance with one or more aspects of the present disclosure. The device 405 may be an example of aspects of a RIS controller as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to equivalent off state for a RIS). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to equivalent off state for a RIS). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of equivalent off state for a RIS as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a controller of a RIS in accordance with examples as disclosed herein. For example, the communications manager 420 may be configured as or otherwise support a means for transmitting a capability message including a capability of one or more configurable elements of the RIS to direct incoming signals in one or more preconfigured directions for one or more frequency bands. The communications manager 420 may be configured as or otherwise support a means for controlling, in accordance with the capability message and an activity status of the RIS, the one or more configurable elements of the RIS to direct a first signal associated with a first frequency band of the one or more frequency bands to a first preconfigured direction of the one or more preconfigured directions.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for a RIS controller, such as a RIS CU, to transmit a capability message to a network entity 105 indicating a capability of the RIS CU to direct signals in one or more directions for one or more frequency bands, where the RIS CU controls configurable elements of a RIS based on the capability message, which may provide for reduced processing, reduced power consumption, more efficient utilization of communication resources, or the like.

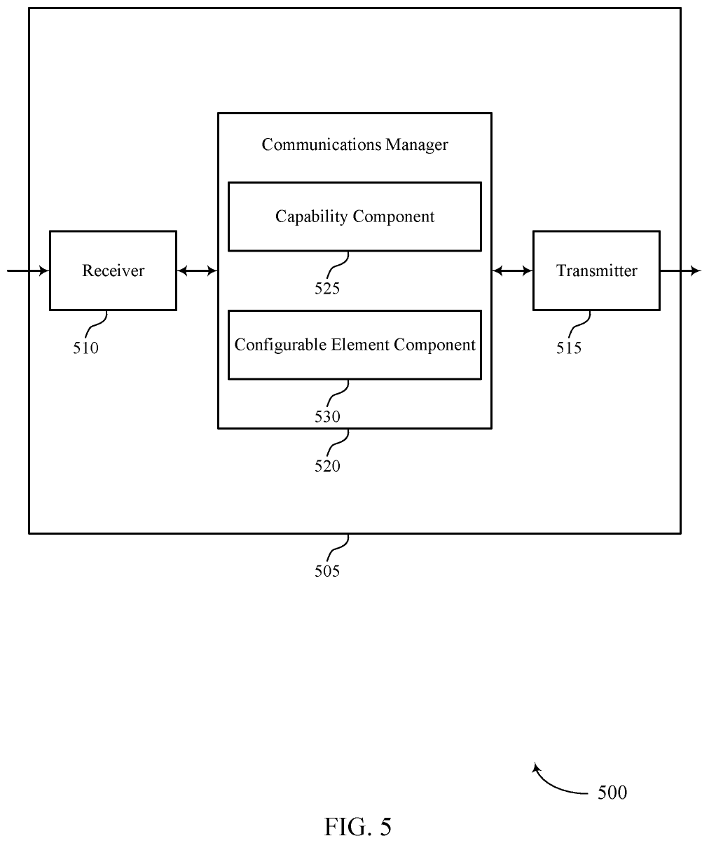

FIG. 5 illustrates a block diagram 500 of a device 505 that supports equivalent off state for a RIS in accordance with one or more aspects of the present disclosure. The device 505 may be an example of aspects of a device 405 or a RIS controller as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to equivalent off state for a RIS). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to equivalent off state for a RIS). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of equivalent off state for a RIS as described herein. For example, the communications manager 520 may include a capability component 525 a configurable element component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a controller of a RIS in accordance with examples as disclosed herein. The capability component 525 may be configured as or otherwise support a means for transmitting a capability message including a capability of one or more configurable elements of the RIS to direct incoming signals in one or more preconfigured directions for one or more frequency bands. The configurable element component 530 may be configured as or otherwise support a means for controlling, in accordance with the capability message and an activity status of the RIS, the one or more configurable elements of the RIS to direct a first signal associated with a first frequency band of the one or more frequency bands to a first preconfigured direction of the one or more preconfigured directions.

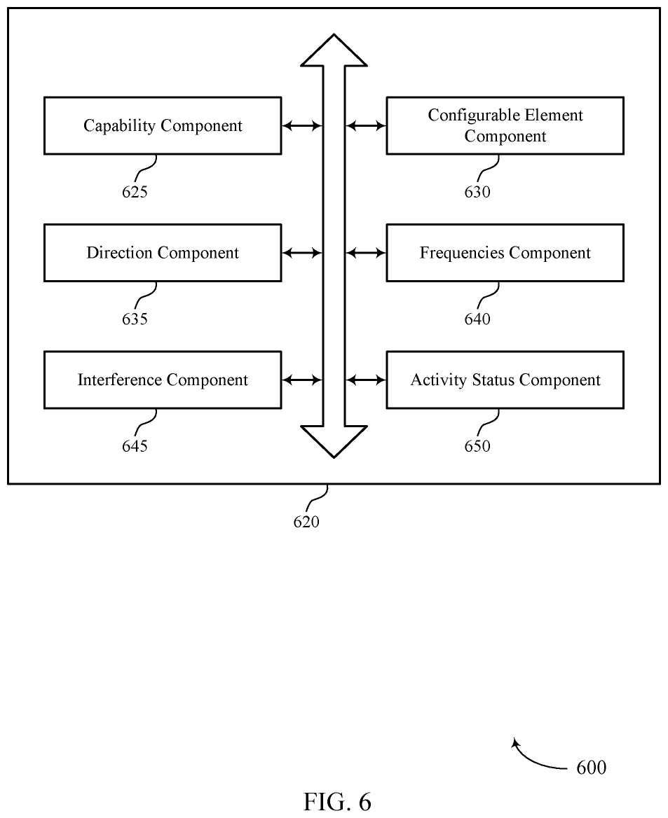

FIG. 6 illustrates a block diagram 600 of a communications manager 620 that supports equivalent off state for a RIS in accordance with one or more aspects of the present disclosure. The communications manager 620 may be an example of aspects of a communications manager 420, a communications manager 520, or both, as described herein. The communications manager 620, or various components thereof, may be an example of means for performing various aspects of equivalent off state for a RIS as described herein. For example, the communications manager 620 may include a capability component 625, a configurable element component 630, a direction component 635, a frequencies component 640, an interference component 645, an activity status component 650, or any combination thereof. Each of these components may communicate, directly or indirectly, with one another (e.g., via one or more buses).

The communications manager 620 may support wireless communication at a controller of a RIS in accordance with examples as disclosed herein. The capability component 625 may be configured as or otherwise support a means for transmitting a capability message including a capability of one or more configurable elements of the RIS to direct incoming signals in one or more preconfigured directions for one or more frequency bands. The configurable element component 630 may be configured as or otherwise support a means for controlling, in accordance with the capability message and an activity status of the RIS, the one or more configurable elements of the RIS to direct a first signal associated with a first frequency band of the one or more frequency bands to a first preconfigured direction of the one or more preconfigured directions.

In some examples, the configurable element component 630 may be configured as or otherwise support a means for receiving control signaling indicating the first preconfigured direction, the first frequency band, or both.

In some examples, to support controlling the one or more configurable elements of the RIS, the configurable element component 630 may be configured as or otherwise support a means for controlling the one or more configurable elements of the RIS to direct the first signal in a same direction as an incoming direction of the first signal, where the first preconfigured direction is based on the incoming direction of the first signal.

In some examples, to support controlling the one or more configurable elements of the RIS, the direction component 635 may be configured as or otherwise support a means for receiving an indication of the first preconfigured direction.

In some examples, the first preconfigured direction includes a set of multiple first preconfigured directions based on the capability message indicating a maximum ratio of reflected power and incident power over the set of multiple first preconfigured directions for the first frequency band.

In some examples, to support controlling the one or more configurable elements of the RIS, the frequencies component 640 may be configured as or otherwise support a means for receiving an indication of a set of multiple frequencies for the one or more configurable elements of the RIS to shift at least a portion of a signal power associated with the directed first signal. In some examples, to support controlling the one or more configurable elements of the RIS, the configurable element component 630 may be configured as or otherwise support a means for controlling the one or more configurable elements to shift at least the portion of the signal power to at least a subset of the set of multiple frequencies.

In some examples, the direction component 635 may be configured as or otherwise support a means for receiving control signaling indicating a second preconfigured direction of the one or more preconfigured directions for the one or more configurable elements of the RIS to direct a second signal associated with a second frequency band of the one or more frequency bands.

In some examples, the interference component 645 may be configured as or otherwise support a means for receiving an indication of a target interference value corresponding to the directed first signal, where controlling the one or more configurable elements of the RIS is in accordance with the target interference value.

In some examples, the activity status component 650 may be configured as or otherwise support a means for determining the activity status based on whether a signal is scheduled to be directed by the RIS towards a target wireless device.

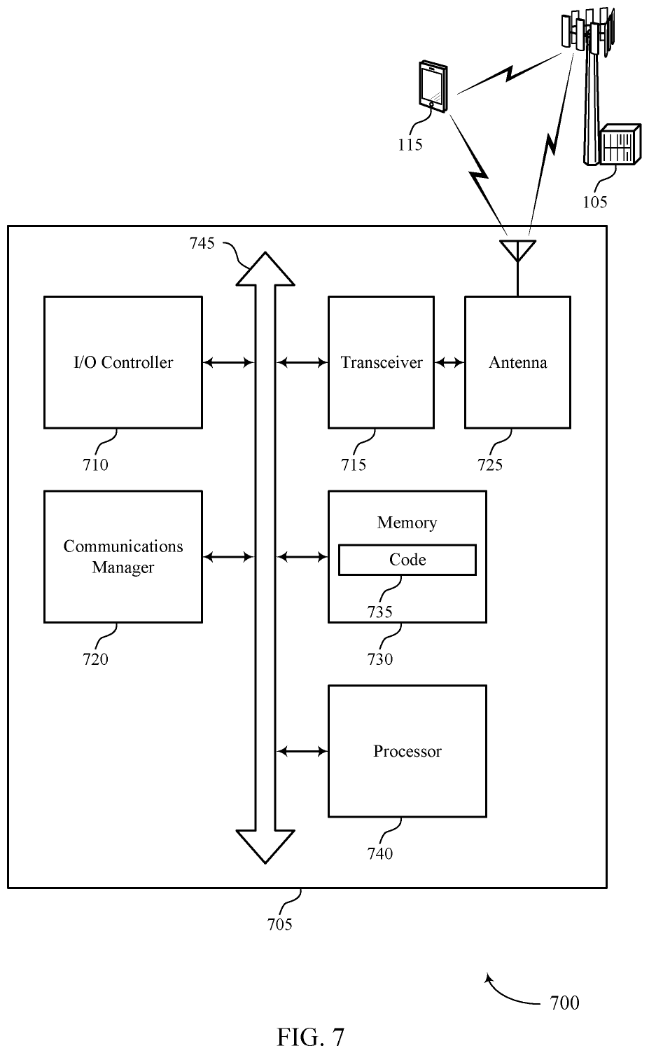

FIG. 7 illustrates a diagram of a system 700 including a device 705 that supports equivalent off state for a RIS in accordance with one or more aspects of the present disclosure. The device 705 may be an example of or include the components of a device 405, a device 505, or a RIS controller as described herein. The device 705 may include components for bi-directional voice and data communications including components for transmitting and receiving communications, such as a communications manager 720, an I/O controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include RAM and ROM. The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a BIOS which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting equivalent off state for a RIS). For example, the device 705 or a component of the device 705 may include a processor 740 and memory 730 coupled with or to the processor 740, the processor 740 and memory 730 configured to perform various functions described herein.

The communications manager 720 may support wireless communication at a controller of a RIS in accordance with examples as disclosed herein. For example, the communications manager 720 may be configured as or otherwise support a means for transmitting a capability message including a capability of one or more configurable elements of the RIS to direct incoming signals in one or more preconfigured directions for one or more frequency bands. The communications manager 720 may be configured as or otherwise support a means for controlling, in accordance with the capability message and an activity status of the RIS, the one or more configurable elements of the RIS to direct a first signal associated with a first frequency band of the one or more frequency bands to a first preconfigured direction of the one or more preconfigured directions.

By including or configuring the communications manager 720 in accordance with examples as described herein, the device 705 may support techniques for a RIS controller, such as a RIS CU, to transmit a capability message to a network entity 105 indicating a capability of the RIS CU to direct signals in one or more directions for one or more frequency bands, where the RIS CU controls configurable elements of a RIS based on the capability message, which may provide for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of equivalent off state for a RIS as described herein, or the processor 740 and the memory 730 may be otherwise configured to perform or support such operations.

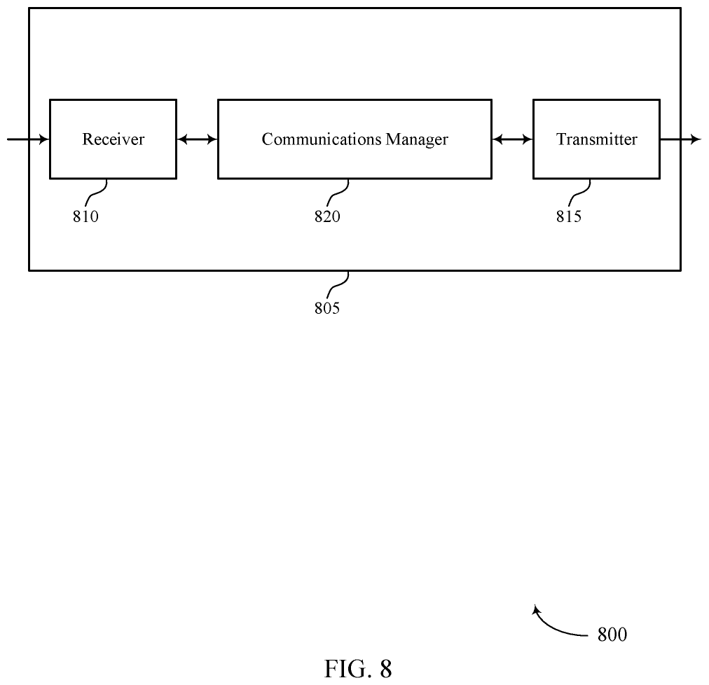

FIG. 8 illustrates a block diagram 800 of a device 805 that supports equivalent off state for a RIS in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of equivalent off state for a RIS as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first network entity in accordance with examples as disclosed herein. For example, the communications manager 820 may be configured as or otherwise support a means for receiving a capability message including a capability of one or more configurable elements of a RIS to direct incoming signals in one or more preconfigured directions for one or more frequency bands. The communications manager 820 may be configured as or otherwise support a means for transmitting, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for a RIS controller, such as a RIS CU, to transmit a capability message to a network entity 105 indicating a capability of the RIS CU to direct signals in one or more directions for one or more frequency bands, where the RIS CU controls configurable elements of a RIS based on the capability message, which may provide for reduced processing, reduced power consumption, more efficient utilization of communication resources, or the like.

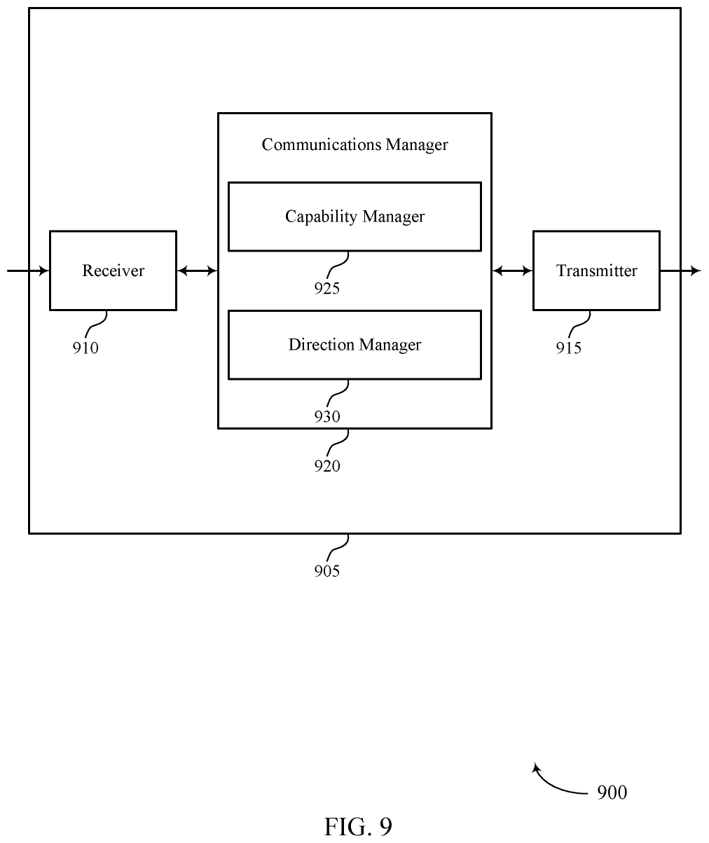

FIG. 9 illustrates a block diagram 900 of a device 905 that supports equivalent off state for a RIS in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of equivalent off state for a RIS as described herein. For example, the communications manager 920 may include a capability manager 925 a direction manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first network entity in accordance with examples as disclosed herein. The capability manager 925 may be configured as or otherwise support a means for receiving a capability message including a capability of one or more configurable elements of a RIS to direct incoming signals in one or more preconfigured directions for one or more frequency bands. The direction manager 930 may be configured as or otherwise support a means for transmitting, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.

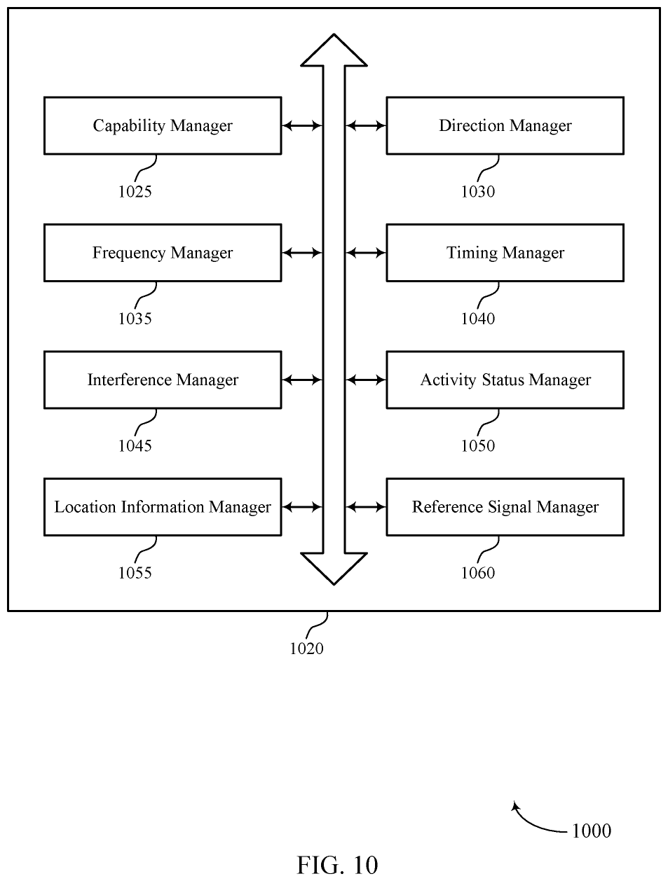

FIG. 10 illustrates a block diagram 1000 of a communications manager 1020 that supports equivalent off state for a RIS in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of equivalent off state for a RIS as described herein. For example, the communications manager 1020 may include a capability manager 1025, a direction manager 1030, a frequency manager 1035, a timing manager 1040, an interference manager 1045, an activity status manager 1050, a location information manager 1055, a reference signal manager 1060, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a first network entity in accordance with examples as disclosed herein. The capability manager 1025 may be configured as or otherwise support a means for receiving a capability message including a capability of one or more configurable elements of a RIS to direct incoming signals in one or more preconfigured directions for one or more frequency bands. The direction manager 1030 may be configured as or otherwise support a means for transmitting, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.

In some examples, the first control signaling indicates the first frequency band of the one or more frequency bands.

In some examples, the frequency manager 1035 may be configured as or otherwise support a means for transmitting, to one or more second network entities, a first message requesting an indication of the one or more frequency bands corresponding to frequency bands in use by the one or more second network entities, where the first message includes a location of the RIS. In some examples, the frequency manager 1035 may be configured as or otherwise support a means for receiving, in response to the first message, at least one second message indicating the first frequency band.

In some examples, the direction manager 1030 may be configured as or otherwise support a means for determining the first preconfigured direction is a same direction as an incoming direction of the first signal, where the capability message indicates an ability of the RIS to direct the first signal in the same direction as the incoming direction of the first signal.

In some examples, the direction manager 1030 may be configured as or otherwise support a means for selecting the first preconfigured direction of the one or more preconfigured directions based on the first preconfigured direction having an interference for one or more wireless devices below a threshold.

In some examples, the location information manager 1055 may be configured as or otherwise support a means for transmitting a message requesting location information corresponding to the one or more wireless devices and requesting an indication of respective frequency bands in use by the one or more wireless devices. In some examples, the location information manager 1055 may be configured as or otherwise support a means for receiving, in response to the message, the location information and the indication of the respective frequency bands, where selecting the first preconfigured direction is in accordance with the location information and the indication of the respective frequency bands.

In some examples, the location information manager 1055 may be configured as or otherwise support a means for transmitting, to one or more second network entities, signaling including the location information, the indication of the respective frequency bands, the first preconfigured direction, or any combination thereof. In some examples, the location information manager 1055 may be configured as or otherwise support a means for receiving updated location information, updated respective frequency bands, or both based on transmitting the signaling.

In some examples, the first preconfigured direction includes a set of multiple preconfigured directions based on the capability message indicating a maximum ratio of reflected power and incident power over the one or more preconfigured directions for the one or more frequency bands.

In some examples, the frequency manager 1035 may be configured as or otherwise support a means for transmitting an indication of a set of multiple frequencies for the one or more configurable elements of the RIS to shift at least a portion of a signal power associated with the directed first signal.

In some examples, the timing manager 1040 may be configured as or otherwise support a means for determining a time period over which the RIS is to direct the first signal in the first preconfigured direction. In some examples, the timing manager 1040 may be configured as or otherwise support a means for transmitting an indication of the time period to one or more second network entities.

In some examples, the interference manager 1045 may be configured as or otherwise support a means for determining that a measurement of interference at a UE associated with a second frequency band of the one or more frequency bands satisfies a threshold interference value. In some examples, the direction manager 1030 may be configured as or otherwise support a means for transmitting second control signaling indicating a second preconfigured direction of the one or more preconfigured directions for the one or more configurable elements of the RIS to direct a second signal associated with the second frequency band.

In some examples, the reference signal manager 1060 may be configured as or otherwise support a means for transmitting signaling including reference signal resources associated with the second frequency band and a request for the measurement of interference associated with the second frequency band. In some examples, the reference signal manager 1060 may be configured as or otherwise support a means for receiving, in response to the signaling, the measurement of interference, where determining the measurement of interference satisfies the threshold interference value is based on receiving the measurement of interference.

In some examples, the frequency manager 1035 may be configured as or otherwise support a means for receiving, from a second network entity, an indication of the second frequency band, where determining the measurement of interference satisfies the threshold interference value is based on receiving the indication of the second frequency band.

In some examples, the interference manager 1045 may be configured as or otherwise support a means for transmitting an indication of a target interference value corresponding to the directed first signal, where controlling the one or more configurable elements of the RIS is in accordance with the target interference value.

In some examples, the activity status manager 1050 may be configured as or otherwise support a means for determining the activity status based on whether a signal is scheduled to be directed by the RIS towards a target wireless device.

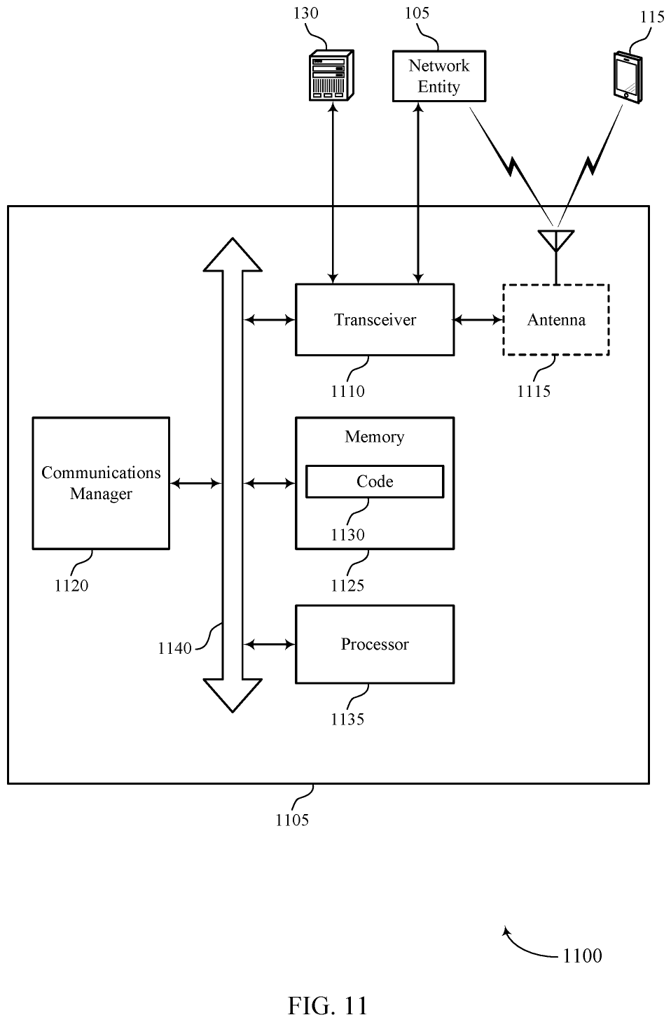

FIG. 11 illustrates a diagram of a system 1100 including a device 1105 that supports equivalent off state for a RIS in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting equivalent off state for a RIS). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a first network entity in accordance with examples as disclosed herein. For example, the communications manager 1120 may be configured as or otherwise support a means for receiving a capability message including a capability of one or more configurable elements of a RIS to direct incoming signals in one or more preconfigured directions for one or more frequency bands. The communications manager 1120 may be configured as or otherwise support a means for transmitting, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.

By including or configuring the communications manager 1120 in accordance with examples as described herein, the device 1105 may support techniques for a RIS controller, such as a RIS CU, to transmit a capability message to a network entity 105 indicating a capability of the RIS CU to direct signals in one or more directions for one or more frequency bands, where the RIS CU controls configurable elements of a RIS based on the capability message, which may provide for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of equivalent off state for a RIS as described herein, or the processor 1135 and the memory 1125 may be otherwise configured to perform or support such operations.

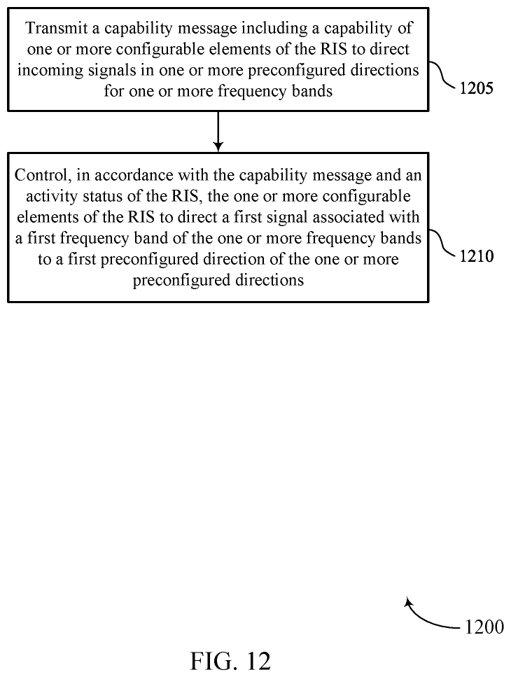

FIG. 12 illustrates a flowchart showing a method 1200 that supports equivalent off state for a RIS in accordance with one or more aspects of the present disclosure. The operations of the method 1200 may be implemented by a RIS controller or its components as described herein. For example, the operations of the method 1200 may be performed by a RIS controller as described with reference to FIGS. 1 through 7. In some examples, a RIS controller may execute a set of instructions to control the functional elements of the RIS controller to perform the described functions. Additionally, or alternatively, the RIS controller may perform aspects of the described functions using special-purpose hardware.

At 1205, the method may include transmitting a capability message including a capability of one or more configurable elements of the RIS to direct incoming signals in one or more preconfigured directions for one or more frequency bands. The operations of 1205 may be performed in accordance with examples as disclosed herein. In some examples, aspects of the operations of 1205 may be performed by a capability component 625 as described with reference to FIG. 6.

At 1210, the method may include controlling, in accordance with the capability message and an activity status of the RIS, the one or more configurable elements of the RIS to direct a first signal associated with a first frequency band of the one or more frequency bands to a first preconfigured direction of the one or more preconfigured directions. The operations of 1210 may be performed in accordance with examples as disclosed herein. In some examples, aspects of the operations of 1210 may be performed by a configurable element component 630 as described with reference to FIG. 6.

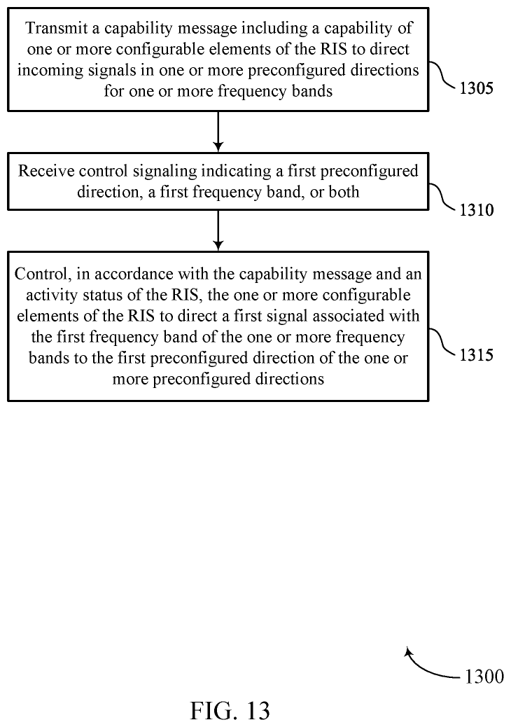

FIG. 13 illustrates a flowchart showing a method 1300 that supports equivalent off state for a RIS in accordance with one or more aspects of the present disclosure. The operations of the method 1300 may be implemented by a RIS controller or its components as described herein. For example, the operations of the method 1300 may be performed by a RIS controller as described with reference to FIGS. 1 through 7. In some examples, a RIS controller may execute a set of instructions to control the functional elements of the RIS controller to perform the described functions. Additionally, or alternatively, the RIS controller may perform aspects of the described functions using special-purpose hardware.

At 1305, the method may include transmitting a capability message including a capability of one or more configurable elements of the RIS to direct incoming signals in one or more preconfigured directions for one or more frequency bands. The operations of 1305 may be performed in accordance with examples as disclosed herein. In some examples, aspects of the operations of 1305 may be performed by a capability component 625 as described with reference to FIG. 6.

At 1310, the method may include receiving control signaling indicating a first preconfigured direction, a first frequency band, or both. The operations of 1310 may be performed in accordance with examples as disclosed herein. In some examples, aspects of the operations of 1310 may be performed by a configurable element component 630 as described with reference to FIG. 6.

At 1315, the method may include controlling, in accordance with the capability message and an activity status of the RIS, the one or more configurable elements of the RIS to direct a first signal associated with the first frequency band of the one or more frequency bands to the first preconfigured direction of the one or more preconfigured directions. The operations of 1315 may be performed in accordance with examples as disclosed herein. In some examples, aspects of the operations of 1315 may be performed by a configurable element component 630 as described with reference to FIG. 6.

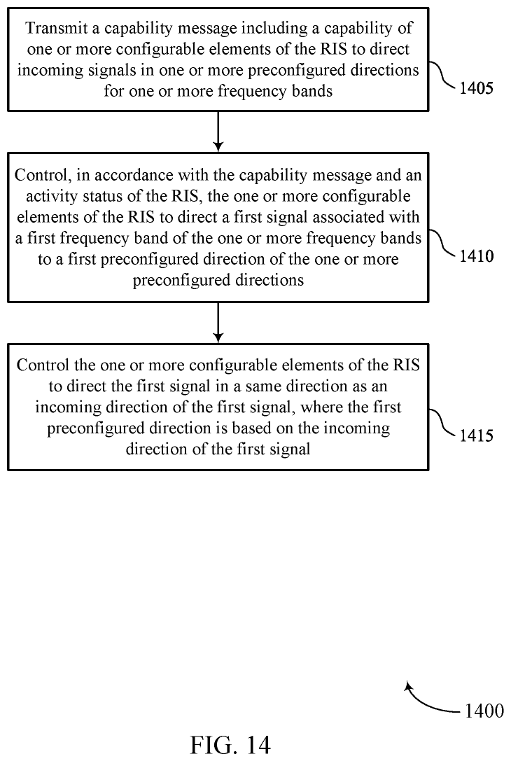

FIG. 14 illustrates a flowchart showing a method 1400 that supports equivalent off state for a RIS in accordance with one or more aspects of the present disclosure. The operations of the method 1400 may be implemented by a RIS controller or its components as described herein. For example, the operations of the method 1400 may be performed by a RIS controller as described with reference to FIGS. 1 through 7. In some examples, a RIS controller may execute a set of instructions to control the functional elements of the RIS controller to perform the described functions. Additionally, or alternatively, the RIS controller may perform aspects of the described functions using special-purpose hardware.

At 1405, the method may include transmitting a capability message including a capability of one or more configurable elements of the RIS to direct incoming signals in one or more preconfigured directions for one or more frequency bands. The operations of 1405 may be performed in accordance with examples as disclosed herein. In some examples, aspects of the operations of 1405 may be performed by a capability component 625 as described with reference to FIG. 6.

At 1410, the method may include controlling, in accordance with the capability message and an activity status of the RIS, the one or more configurable elements of the RIS to direct a first signal associated with a first frequency band of the one or more frequency bands to a first preconfigured direction of the one or more preconfigured directions. The operations of 1410 may be performed in accordance with examples as disclosed herein. In some examples, aspects of the operations of 1410 may be performed by a configurable element component 630 as described with reference to FIG. 6.

At 1415, the method may include controlling the one or more configurable elements of the RIS to direct the first signal in a same direction as an incoming direction of the first signal, where the first preconfigured direction is based on the incoming direction of the first signal. The operations of 1415 may be performed in accordance with examples as disclosed herein. In some examples, aspects of the operations of 1415 may be performed by a configurable element component 630 as described with reference to FIG. 6.

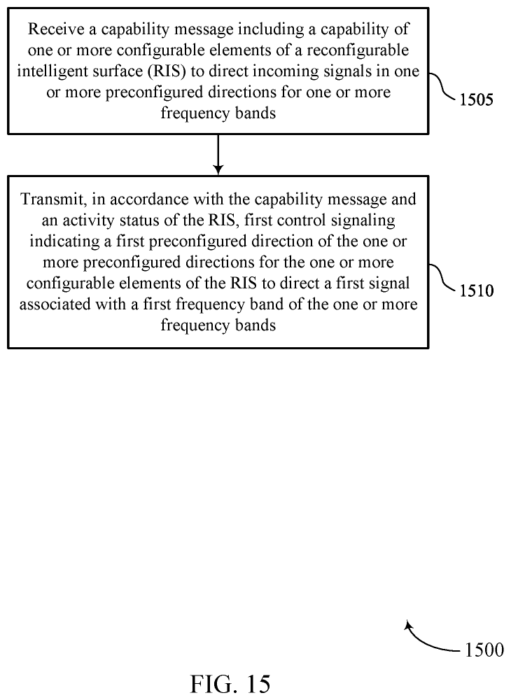

FIG. 15 illustrates a flowchart showing a method 1500 that supports equivalent off state for a RIS in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include receiving a capability message including a capability of one or more configurable elements of a RIS to direct incoming signals in one or more preconfigured directions for one or more frequency bands. The operations of 1505 may be performed in accordance with examples as disclosed herein. In some examples, aspects of the operations of 1505 may be performed by a capability manager 1025 as described with reference to FIG. 10.

At 1510, the method may include transmitting, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands. The operations of 1510 may be performed in accordance with examples as disclosed herein. In some examples, aspects of the operations of 1510 may be performed by a direction manager 1030 as described with reference to FIG. 10.

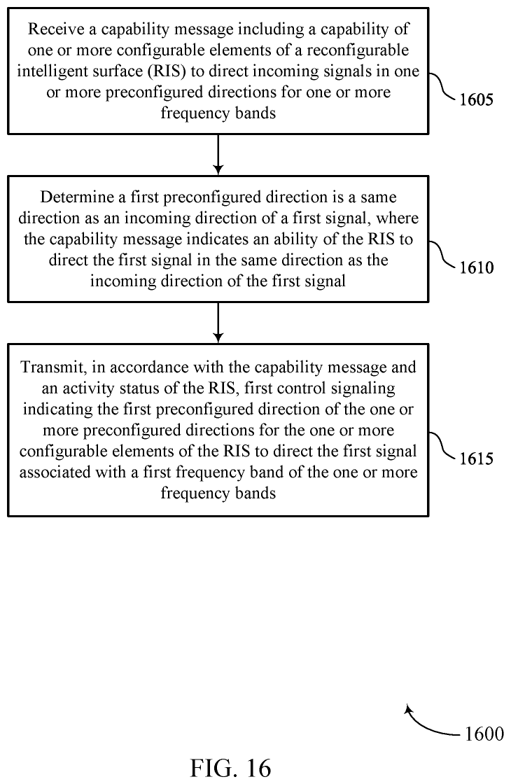

FIG. 16 illustrates a flowchart showing a method 1600 that supports equivalent off state for a RIS in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include receiving a capability message including a capability of one or more configurable elements of a RIS to direct incoming signals in one or more preconfigured directions for one or more frequency bands. The operations of 1605 may be performed in accordance with examples as disclosed herein. In some examples, aspects of the operations of 1605 may be performed by a capability manager 1025 as described with reference to FIG. 10.

At 1610, the method may include determining the first preconfigured direction is a same direction as an incoming direction of the first signal, where the capability message indicates an ability of the RIS to direct the first signal in the same direction as the incoming direction of the first signal. The operations of 1610 may be performed in accordance with examples as disclosed herein. In some examples, aspects of the operations of 1610 may be performed by a direction manager 1030 as described with reference to FIG. 10.

At 1615, the method may include transmitting, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands. The operations of 1615 may be performed in accordance with examples as disclosed herein. In some examples, aspects of the operations of 1615 may be performed by a direction manager 1030 as described with reference to FIG. 10.

The following provides an overview of aspects of the present disclosure:
Aspect 1: A method for wireless communication at a controller of a reconfigurable intelligent surface (RIS), comprising: transmitting a capability message comprising a capability of one or more configurable elements of the RIS to direct incoming signals in one or more preconfigured directions for one or more frequency bands; and controlling, in accordance with the capability message and an activity status of the RIS, the one or more configurable elements of the RIS to direct a first signal associated with a first frequency band of the one or more frequency bands to a first preconfigured direction of the one or more preconfigured directions.
Aspect 2: The method of aspect 1, further comprising: receiving control signaling indicating the first preconfigured direction, the first frequency band, or both.
Aspect 3: The method of any of aspects 1 through 2, wherein controlling the one or more configurable elements of the RIS further comprises: controlling the one or more configurable elements of the RIS to direct the first signal in a same direction as an incoming direction of the first signal, wherein the first preconfigured direction is based at least in part on the incoming direction of the first signal.
Aspect 4: The method of any of aspects 1 through 3, wherein controlling the one or more configurable elements of the RIS further comprises: receiving an indication of the first preconfigured direction.
Aspect 5: The method of any of aspects 1 through 4, wherein the first preconfigured direction comprises a plurality of first preconfigured directions based at least in part on the capability message indicating a maximum ratio of reflected power and incident power over the plurality of first preconfigured directions for the first frequency band.
Aspect 6: The method of any of aspects 1 through 5, wherein controlling the one or more configurable elements of the RIS further comprises: receiving an indication of a plurality of frequencies for the one or more configurable elements of the RIS to shift at least a portion of a signal power associated with the directed first signal; and controlling the one or more configurable elements to shift at least the portion of the signal power to at least a subset of the plurality of frequencies.
Aspect 7: The method of any of aspects 1 through 6, further comprising: receiving control signaling indicating a second preconfigured direction of the one or more preconfigured directions for the one or more configurable elements of the RIS to direct a second signal associated with a second frequency band of the one or more frequency bands.
Aspect 8: The method of any of aspects 1 through 7, further comprising: receiving an indication of a target interference value corresponding to the directed first signal; and determining the activity status based at least in part on the target interference value and the capability of the one or more configurable elements of the RIS to direct the incoming signals in the one or more preconfigured directions for the one or more frequency bands.
Aspect 9: The method of any of aspects 1 through 8, further comprising: determining the activity status based at least in part on whether a signal is scheduled to be directed by the RIS towards a target wireless device.
Aspect 10: A method for wireless communication at a first network entity, comprising: receiving a capability message comprising a capability of one or more configurable elements of a reconfigurable intelligent surface (RIS) to direct incoming signals in one or more preconfigured directions for one or more frequency bands; and transmitting, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.
Aspect 11: The method of aspect 10, wherein the first control signaling indicates the first frequency band of the one or more frequency bands.
Aspect 12: The method of aspect 11, further comprising: transmitting, to one or more second network entities, a first message requesting an indication of the one or more frequency bands corresponding to frequency bands in use by the one or more second network entities, wherein the first message comprises a location of the RIS; and receiving, in response to the first message, at least one second message indicating the first frequency band.
Aspect 13: The method of any of aspects 10 through 12, further comprising: determining the first preconfigured direction is a same direction as an incoming direction of the first signal, wherein the capability message indicates an ability of the RIS to direct the first signal in the same direction as the incoming direction of the first signal.
Aspect 14: The method of any of aspects 10 through 13, further comprising: selecting the first preconfigured direction of the one or more preconfigured directions based at least in part on the first preconfigured direction having an interference for one or more wireless devices below a threshold.
Aspect 15: The method of aspect 14, further comprising: transmitting a message requesting location information corresponding to the one or more wireless devices and requesting an indication of respective frequency bands in use by the one or more wireless devices; and receiving, in response to the message, the location information and the indication of the respective frequency bands, wherein selecting the first preconfigured direction is in accordance with the location information and the indication of the respective frequency bands.
Aspect 16: The method of aspect 15, further comprising: transmitting, to one or more second network entities, signaling comprising the location information, the indication of the respective frequency bands, the first preconfigured direction, or any combination thereof; and receiving updated location information based at least in part on transmitting the signaling.
Aspect 17: The method of any of aspects 10 through 16, wherein the first preconfigured direction comprises a plurality of preconfigured directions based at least in part on the capability message indicating a maximum ratio of reflected power and incident power over the one or more preconfigured directions for the one or more frequency bands.
Aspect 18: The method of any of aspects 10 through 17, further comprising: transmitting an indication of a plurality of frequencies for the one or more configurable elements of the RIS to shift at least a portion of a signal power associated with the directed first signal.
Aspect 19: The method of any of aspects 10 through 18, further comprising: determining a time period over which the RIS is to direct the first signal in the first preconfigured direction; and transmitting an indication of the time period to one or more second network entities.
Aspect 20: The method of any of aspects 10 through 19, further comprising: determining that a measurement of interference at a UE associated with a second frequency band of the one or more frequency bands satisfies a threshold interference value; and transmitting second control signaling indicating a second preconfigured direction of the one or more preconfigured directions for the one or more configurable elements of the RIS to direct a second signal associated with the second frequency band.
Aspect 21: The method of aspect 20, further comprising: transmitting signaling comprising reference signal resources associated with the second frequency band and a request for the measurement of interference associated with the second frequency band; and receiving, in response to the signaling, the measurement of interference, wherein determining the measurement of interference satisfies the threshold interference value is based at least in part on receiving the measurement of interference.
Aspect 22: The method of any of aspects 20 through 21, further comprising: receiving, from a second network entity, an indication of the second frequency band, wherein determining the measurement of interference satisfies the threshold interference value is based at least in part on receiving the indication of the second frequency band.
Aspect 23: The method of any of aspects 10 through 22, further comprising: transmitting an indication of a target interference value corresponding to the directed first signal.
Aspect 24: The method of any of aspects 10 through 23, further comprising: determining the activity status based at least in part on whether a signal is scheduled to be directed by the RIS towards a target wireless device.
Aspect 25: An apparatus for wireless communication at a controller of a reconfigurable intelligent surface (RIS), comprising a processor; memory coupled with the processor; and instructions stored in the memory and executable by the processor to cause the apparatus to perform a method of any of aspects 1 through 9.
Aspect 26: An apparatus for wireless communication at a controller of a reconfigurable intelligent surface (RIS), comprising at least one means for performing a method of any of aspects 1 through 9.
Aspect 27: A non-transitory computer-readable medium storing code for wireless communication at a controller of a reconfigurable intelligent surface (RIS), the code comprising instructions executable by a processor to perform a method of any of aspects 1 through 9.
Aspect 28: An apparatus for wireless communication at a first network entity, comprising a processor; memory coupled with the processor; and instructions stored in the memory and executable by the processor to cause the apparatus to perform a method of any of aspects 10 through 24.
Aspect 29: An apparatus for wireless communication at a first network entity, comprising at least one means for performing a method of any of aspects 10 through 24.
Aspect 30: A non-transitory computer-readable medium storing code for wireless communication at a first network entity, the code comprising instructions executable by a processor to perform a method of any of aspects 10 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a controller of a reconfigurable intelligent surface (RIS), comprising:
a processor;
memory coupled with the processor; and
instructions stored in the memory and executable by the processor to cause the apparatus to:
transmit a capability message comprising a capability of one or more configurable elements of the RIS to direct incoming signals in one or more preconfigured directions for one or more frequency bands; and
control, in accordance with the capability message and an activity status of the RIS, the one or more configurable elements of the RIS to direct a first signal associated with a first frequency band of the one or more frequency bands to a first preconfigured direction of the one or more preconfigured directions.

2. The apparatus of claim 1, wherein the instructions are further executable by the processor to cause the apparatus to:
receive control signaling indicating the first preconfigured direction, the first frequency band, or both.

3. The apparatus of claim 1, wherein the instructions to control the one or more configurable elements of the RIS are further executable by the processor to cause the apparatus to:
control the one or more configurable elements of the RIS to direct the first signal in a same direction as an incoming direction of the first signal, wherein the first preconfigured direction is based at least in part on the incoming direction of the first signal.

4. The apparatus of claim 1, wherein the instructions to control the one or more configurable elements of the RIS are further executable by the processor to cause the apparatus to:
receive an indication of the first preconfigured direction.

5. The apparatus of claim 1, wherein the first preconfigured direction comprises a plurality of first preconfigured directions based at least in part on the capability message indicating a maximum ratio of reflected power and incident power over the plurality of first preconfigured directions for the first frequency band.

6. The apparatus of claim 1, wherein the instructions to control the one or more configurable elements of the RIS are further executable by the processor to cause the apparatus to:
receive an indication of a plurality of frequencies for the one or more configurable elements of the RIS to shift at least a portion of a signal power associated with the directed first signal; and
control the one or more configurable elements to shift at least the portion of the signal power to at least a subset of the plurality of frequencies.

7. The apparatus of claim 1, wherein the instructions are further executable by the processor to cause the apparatus to:
receive control signaling indicating a second preconfigured direction of the one or more preconfigured directions for the one or more configurable elements of the RIS to direct a second signal associated with a second frequency band of the one or more frequency bands.

8. The apparatus of claim 1, wherein the instructions are further executable by the processor to cause the apparatus to:
receive an indication of a target interference value corresponding to the directed first signal, wherein controlling the one or more configurable elements of the RIS is in accordance with the target interference value.

9. The apparatus of claim 1, wherein the instructions are further executable by the processor to cause the apparatus to:
determine the activity status based at least in part on whether a signal is scheduled to be directed by the RIS towards a target wireless device.

10. An apparatus for wireless communication at a first network entity, comprising:
a processor;
memory coupled with the processor; and
instructions stored in the memory and executable by the processor to cause the apparatus to:
receive a capability message comprising a capability of one or more configurable elements of a reconfigurable intelligent surface (RIS) to direct incoming signals in one or more preconfigured directions for one or more frequency bands; and
transmit, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.

11. The apparatus of claim 10, wherein the first control signaling indicates the first frequency band of the one or more frequency bands.

12. The apparatus of claim 11, wherein the instructions are further executable by the processor to cause the apparatus to:
transmit, to one or more second network entities, a first message requesting an indication of the one or more frequency bands corresponding to frequency bands in use by the one or more second network entities, wherein the first message comprises a location of the RIS; and
receive, in response to the first message, at least one second message indicating the first frequency band.

13. The apparatus of claim 10, wherein the instructions are further executable by the processor to cause the apparatus to:
determine the first preconfigured direction is a same direction as an incoming direction of the first signal, wherein the capability message indicates an ability of the RIS to direct the first signal in the same direction as the incoming direction of the first signal.

14. The apparatus of claim 10, wherein the instructions are further executable by the processor to cause the apparatus to:
select the first preconfigured direction of the one or more preconfigured directions based at least in part on the first preconfigured direction having an interference for one or more wireless devices below a threshold.

15. The apparatus of claim 14, wherein the instructions are further executable by the processor to cause the apparatus to:
transmit a message requesting location information corresponding to the one or more wireless devices and requesting an indication of respective frequency bands in use by the one or more wireless devices; and
receive, in response to the message, the location information and the indication of the respective frequency bands, wherein selecting the first preconfigured direction is in accordance with the location information and the indication of the respective frequency bands.

16. The apparatus of claim 15, wherein the instructions are further executable by the processor to cause the apparatus to:
transmit, to one or more second network entities, signaling comprising the location information, the indication of the respective frequency bands, the first preconfigured direction, or any combination thereof; and
receive updated location information, updated respective frequency bands, or both based at least in part on transmitting the signaling.

17. The apparatus of claim 10, wherein the first preconfigured direction comprises a plurality of preconfigured directions based at least in part on the capability message indicating a maximum ratio of reflected power and incident power over the one or more preconfigured directions for the one or more frequency bands.

18. The apparatus of claim 10, wherein the instructions are further executable by the processor to cause the apparatus to:
transmit an indication of a plurality of frequencies for the one or more configurable elements of the RIS to shift at least a portion of a signal power associated with the directed first signal.

19. The apparatus of claim 10, wherein the instructions are further executable by the processor to cause the apparatus to:
determine a time period over which the RIS is to direct the first signal in the first preconfigured direction; and
transmit an indication of the time period to one or more second network entities.

20. The apparatus of claim 10, wherein the instructions are further executable by the processor to cause the apparatus to:
determine that a measurement of interference at a user equipment (UE) associated with a second frequency band of the one or more frequency bands satisfies a threshold interference value; and
transmit second control signaling indicating a second preconfigured direction of the one or more preconfigured directions for the one or more configurable elements of the RIS to direct a second signal associated with the second frequency band.

21. The apparatus of claim 20, wherein the instructions are further executable by the processor to cause the apparatus to:
transmit signaling comprising reference signal resources associated with the second frequency band and a request for the measurement of interference associated with the second frequency band; and
receive, in response to the signaling, the measurement of interference, wherein determining the measurement of interference satisfies the threshold interference value is based at least in part on receiving the measurement of interference.

22. The apparatus of claim 20, wherein the instructions are further executable by the processor to cause the apparatus to:
receive, from a second network entity, an indication of the second frequency band, wherein determining the measurement of interference satisfies the threshold interference value is based at least in part on receiving the indication of the second frequency band.

23. The apparatus of claim 10, wherein the instructions are further executable by the processor to cause the apparatus to:
transmit an indication of a target interference value corresponding to the directed first signal.

24. The apparatus of claim 10, wherein the instructions are further executable by the processor to cause the apparatus to:
determine the activity status based at least in part on whether a signal is scheduled to be directed by the RIS towards a target wireless device.

25. A method for wireless communication at a controller of a reconfigurable intelligent surface (RIS), comprising:
transmitting a capability message comprising a capability of one or more configurable elements of the RIS to direct incoming signals in one or more preconfigured directions for one or more frequency bands; and
controlling, in accordance with the capability message and an activity status of the RIS, the one or more configurable elements of the RIS to direct a first signal associated with a first frequency band of the one or more frequency bands to a first preconfigured direction of the one or more preconfigured directions.

26. The method of claim 25, further comprising:
receiving control signaling indicating the first preconfigured direction, the first frequency band, or both.

27. The method of claim 25, wherein controlling the one or more configurable elements of the RIS further comprises:
controlling the one or more configurable elements of the RIS to direct the first signal in a same direction as an incoming direction of the first signal, wherein the first preconfigured direction is based at least in part on the incoming direction of the first signal.

28. The method of claim 25, wherein controlling the one or more configurable elements of the RIS further comprises:
receiving an indication of the first preconfigured direction.

29. The method of claim 25, wherein the first preconfigured direction comprises a plurality of first preconfigured directions based at least in part on the capability message indicating a maximum ratio of reflected power and incident power over the plurality of first preconfigured directions for the first frequency band.

30. A method for wireless communication at a first network entity, comprising:
receiving a capability message comprising a capability of one or more configurable elements of a reconfigurable intelligent surface (RIS) to direct incoming signals in one or more preconfigured directions for one or more frequency bands; and
transmitting, in accordance with the capability message and an activity status of the RIS, first control signaling indicating a first preconfigured direction of the one or more preconfigured directions for the one or more configurable elements of the RIS to direct a first signal associated with a first frequency band of the one or more frequency bands.
